(19) United States
(12) Patent Application Publication
(10) Pub. No.: US 2016/0120743 A1
(43) Pub. Date: May 5, 2016

(54) SUPPORT FOR A UNIT DOSE DRUG

(71) Applicant: SWISSLOG ITALIA S.P.A., Milano (MI) (IT)

(72) Inventors: Flavio ESTE, Selvazzano Dentro (PD) (IT); Lorenzo SPAGNA, Guastalla (RE) (IT); Roberto VECCHI, Spilamberto (MO) (IT)

(21) Appl. No.: 14/898,635

(22) PCT Filed: Jun. 26, 2013
(86) PCT No.: PCT/IB2013/055238

§ 371 Date: Dec. 15, 2015

(51) Int. Cl. A61J 1/03; B65D 73/00; B65B 61/02; B65D 75/36; B65B 15/02; B65B 61/06

(52) U.S. Cl. CPC A61J 1/035; B65B 15/02; B65B 61/06; B65B 61/02; B65D 75/366; B65D 73/0057

(57) ABSTRACT

A support for a unit dose drug includes a relatively rigid planar body which is elongate in shape in a first direction and has a thickness which is relatively smaller in relation to a surface area. On one portion of the surface area is provided an accommodation area for a unit dose drug, which area is completely displaced to one side relative to a midline of the surface area, transverse of the first main direction. A hole is provided for hanging the drug support on a peg of a unit dose drug store.

The present invention relates to the field of automated drug management, and more particularly concerns automated unit dose drug management. The invention was developed with particular regard to a support for a unit dose drug.

Various systems for packaging, storing and dispensing unit dose drugs are known and are put to particularly beneficial and advantageous use in a hospital environment. One such system, developed by the present applicant and described in EP 1 346 929, comprises a store designed automatically to manage the quantity of stored drugs, requests for supply, as well as the expiry dates for each drug in storage.

In the prior art system described in EP 1 346 929, the drugs are packaged in unit doses, each placed within an associated sachet on which are stated the details of the specific drug, such as for example the trade name thereof, the active ingredient, the production batch and the expiry date, in both text and bar code form. The sachets containing the unit dose drugs are hung on pegs in the store, ready to be withdrawn in response to a prescription from hospital medical staff. For distribution to the various hospital departments, the sachets containing the unit dose drugs for a single prescription are grouped together by means of ring connector, as described in EP 1 346 931 from the same applicant. Each ring is made up of the prescribed drugs in chronological order of administration, and is provided with a label containing all the details of the patient for whom it is intended.

The known system briefly discussed above has resolved major issues in unit dose drug management in the context of hospital facilities, where it has proved to be efficient and well regarded. The present applicant has, however, decided to develop the unit dose drug management system further in order to improve its features and make it still more advantageous, above all in terms of greater efficiency and reliability, as well as in terms of lower cost, both with regard to installation thereof and ordinary management operations.

This reason for this is that the applicant has observed over the years of experience gained in developing and supplying the above-described system that packaging the unit dose drugs in sachets gives rises to some difficulties due to the need to handle a substantially floppy object which firstly has to be obtained from a strip or the like by means of welding operations, must then be held open at one end for introduction of the unit dose of drug before being sealed shut, and then has to be handled throughout the steps of storage, withdrawal, grouping and delivery of the unit dose drugs to the hospital departments. Indicating the details for the specific drug on the sachet is also an operation which is not easy to carry out.

In order to overcome the above-stated difficulties and improve the unit dose drug management system, the present invention relates to a support for a unit dose drug comprising a relatively rigid planar body which is elongate in shape in a first direction and has a thickness which is relatively smaller in relation to a surface area. On one portion of said surface area is provided an accommodation area for a unit dose drug, which area is completely displaced to one side relative to a transverse midline plane, transverse of said first main direction.

The elongate shape of the planar body is advantageously substantially a rectangle, and the planar body resembles a card of the type of a credit card or the like.

Advantageously, the drug support comprises at least one hole for hanging the drug support on a peg of a unit dose drug store. In this manner, it is possible to use the new supports of the present invention with prior art stores, both alone and in combination with known, sachet-type supports. Advantageously, the hole in the support is arranged on the opposite side of the midline relative to the accommodation area for the unit dose drug, preferably offset relative to a line of symmetry parallel to the first main direction.

This positioning of the hole on the support leaves plenty of space on the planar body for the informative details about the drug, advantageously shown on the opposite side of the midline relative to the accommodation area for the unit dose drug. The details are printed directly on the planar body, or are printed on a label attached to the planar body.

Advantageously, the accommodation area for the unit dose drug comprises a blister housing or recess in which the unit dose drug is placed. The blister housing or recess is covered by a cover flap which is attached to the planar body and is intended to be opened during use when extracting the unit dose drug from the support.

In one example, the blister housing or recess is integral with the planar body. In another example, the blister housing or recess is in contrast a vessel body inserted in an opening of the planar body, and comprises an edge zone attached to the latter.

The blister housing or recess may also be a blister containing a unit dose drug and having an edge zone attached to the planar body.

The cover flap of the blister housing or recess may be made integral with the planar body, by means of one or more incisions which define at least the majority of the outline thereof, in such a manner as to provide predetermined breaking lines. The incision may, for example, be an uninterrupted incision with a depth which is less than the thickness of the planar body, or a discontinuous incision made up of a plurality of relatively long incision sections passing through the thickness of the planar body alternating with relatively shorter unincised sections. In this latter example, the incision sections and the unincised sections together form the broken outline of a breaking line.

In one variant, the cover flap may be made integral with the planar body and comprise a continuous, open incision along a majority of the profile of a geometric figure, for example of a square. In this latter case, the planar body zone corresponding to a fourth side of the square, or more generally the minority of the profile of the geometric figure, has an incision or precut in the manner of a plastic hinge, to facilitate bending of a tab of the planar body material which thus acts as a cover flap for the blister housing or recess.

The invention also provides a machine for manufacturing a drug support. Such a machine comprises a strip material feeder and a first cutting station for making a first incision in the strip. A store contains the unit dose drugs contained in blisters (B), fed to an attachment station in which the blister is attached to the strip. A print station prints details associated with the specific drug, and a second cutting station finally cuts the strip to the desired size, such that the cut section of strip forms the planar body of the support.

In said machine, the first cutting station advantageously comprises a laser cutting tool which makes the incisions and holes. The attachment station advantageously comprises an ultrasound attachment tool.

The invention is furthermore directed to a method for manufacturing a drug support comprising the following steps:
feeding a strip material,
making a first incision in the strip in a first cutting station,
feeding unit dose drugs contained in blisters from a store,
attaching the blister to the strip in an attachment station,
printing details associated with the specific drug in a print station,
cutting the strip to the size corresponding to the planar body in a second cutting station.

Further features and advantages will emerge from the following detailed description of some preferred embodiments of the invention, given purely by way of non-limiting example, with reference to the attached drawings in which:

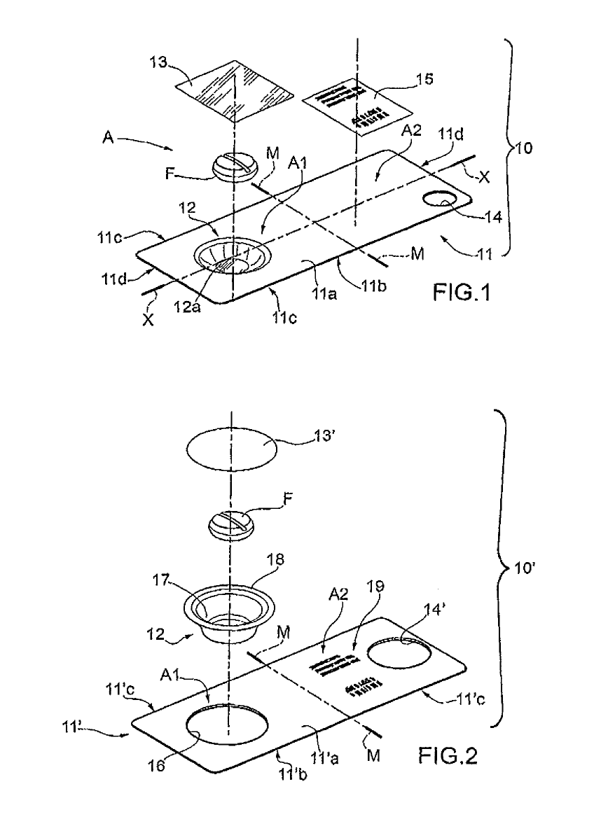

FIG. 1 is an exploded view of a support for a unit dose drug according to the present invention, for use with loose drugs,

FIG. 2 is an exploded view of a variant of the support for a unit dose drug of FIG. 1, for use with loose drugs,

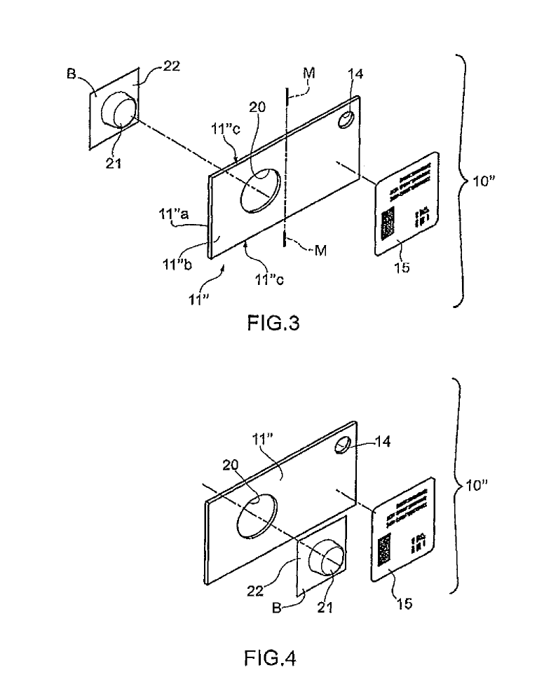

FIG. 3 is a perspective view of another embodiment of a support for a unit dose drug according to the present invention, for use with drugs in blisters,

FIG. 4 is a perspective view of a variant of the support for a unit dose drug of FIG. 3, for use with drugs in blisters,

FIGS. 5 to 9 are perspective views of further variants of the second embodiment of the support for a unit dose drug, for use with drugs in blisters, and

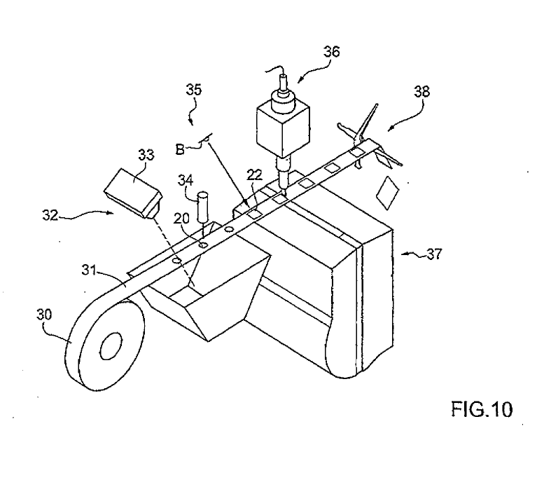

FIG. 10 is a schematic view of an example of a machine usable for manufacturing the support for a unit dose drug of FIG. 3.

Making reference to FIG. 1, a support 10 for a unit dose drug F comprises a planar body 11 which is of slight thickness and relatively elongated in a main direction X, with two opposing planar faces 11a, 11b, each overall of an area A. A midline plane indicated M-M in FIG. 1, transverse of the main direction X, preferably divides the planar body into two portions A1 and A2 of substantially equal area. Preferably, although not exclusively, the planar body 11 is rectangular in shape, with two major sides 11c and two minor sides 11d, preferably although not exclusively of approximately half the length of the major sides 11c, such that the two portions A1 and A2 are substantially square, or rectangular with a ratio between the sides of around one.

The planar body 11 is preferably made from a rigid or semirigid material, i.e. so as to impart thereto a certain intrinsic rigidity in maintaining planarity. The planar body 11 may, however, also exhibit a certain resilient flexibility relative to the main plane of extension thereof. Materials suitable for making the planar body 11 are preferably plastics materials, in particular but not exclusively polypropylene, although the possibility of making the planar body 11 from rigid or semirigid materials of a different kind, such as for example metals or metal alloys (for example aluminium and the alloys thereof), composite materials (for example glass-reinforced plastic or fibre-reinforced materials), or also paperboard or cardboard or similar materials is not ruled out.

On the planar body 11, in a preferably centred position on the portion A1, and thus displaced laterally relative to the midline plane M-M, is formed a blister housing 12 having an indentation 12a on the face 11a of the planar body 11, and correspondingly projecting from the face 11b of the planar body 11. The blister housing 12 is produced for example by moulding or hot or cold plastic deformation of the material of the planar body 11. A unit dose drug F, for example a loose tablet or pill, is placed in the indentation 12a of the blister housing 12. Placing of the unit dose drug F in the indentation 12a will not be further discussed since it is known in the sector, where pick and place means for example making use of the container described in EP 1 016 597 from the same applicant are conventionally used.

The indentation 12a of the blister housing 12 is closed by a bottom 13 of material capable of sealing the space inside the blister housing 12. The bottom 13 is bonded to the planar body 11 for example by means of adhesive bonding or welding, for example ultrasound welding, or another method known in the sector. The material of the bottom 13 is preferably of the aluminium foil type which breaks or tears when subjected to pressure exerted by the drug F pushed by a user pressing on the blister housing 12, on the convex side thereof on the face 11b, opposite the bottom 13, in a manner which is entirely similar to the process of extracting drugs from ordinary blister packs used in the pharmaceutical sector.

A through-hole 14 is made in the planar body 11, preferably close to one end thereof, more preferably an end remote from the blister housing 12, and thus in portion A2 of planar body, and still more preferably a zone close to a corner of the planar body 11 as shown in FIG. 1, which through-hole may be used for example for hanging the support 10 on a peg of an automatic store and/or for using a strip, ring, peg or similar grouping system for grouping a plurality of supports 10, for example making up a set of unit dose drugs F in a single medical prescription.

Two relatively large planar zones which are not occupied by either the blister housing 12 or the hole 14 remain available on faces 11a and 11b of the planar body 11, which planar zones may be used for showing details associated with the specific drug F, such as for example the trade name thereof, the active ingredient, the production batch and the expiry date, in both text and bar code form. FIG. 1 shows a solution which comprises a preferably adhesive information label 15 on which are shown the details associated with the specific drug F, which label is applied to the free planar zone of face 11a of the planar body 11. Applying the information label 15 on face 11a of the planar body 11 is advantageous when producing the support 10, since the information label 15 remains visible on the upper face of the planar body 11 in the position shown in FIG. 1, in which the unit dose drug F is stably accommodated in the cavity 12a.

The information label 15 could of course be applied in an entirely similar manner to the free planar zone of the opposite face 11b of the planar body 11, from which the blister housing 12 projects. This solution has the advantage that, in the final form in which the support 10 is used, the planar body 11 can be placed flat with its face 11a on a supporting surface while keeping the details printed on the information label 15 visible. If the blister housing 12 is made transparent, it is still possible in this position of the support 10 resting on face 11b of the planar body 11 to see the contents of the blister housing 12, in particular the unit dose drug F present in the cavity 12a. It is, of course, also possible to apply two information labels 15, one on each face 11a, 11b of the planar body 11.

The details about the drug F may also be reproduced or printed directly on faces 11a and/or 11b, as will be described in greater detail below with reference to variants of the support 10, for example but not exclusively by means of preferably contactless laser printing technology, or using screen printing systems or any other known printing method.

As is clear from FIG. 1, providing a rectangular-shaped planar body 11 with a blister housing 12 provided on portion A1 relative to the midline M-M, and providing the hole 14 in the vicinity of a corner of the planar body 11 on the other portion A2, makes it possible to have a large free area of the planar body 11 available on which to print the details associated with drug F or on which to apply the information label 15.

FIG. 2 shows a variant 10′ of the support for a unit dose drug F. Said variant comprises a planar body 11′, in this case too preferably but not exclusively rectangular in shape with a transverse midline plane M-M of the major sides 11′c thereof. On portion A1 of the planar body 11′ divided by the midline plane M-M is located a through-hole 16 within which is inserted a blister housing 12 obtained from a vessel body 17 which projects from face 11′b of the planar body 11′. To this end, a peripheral edge 18 of the vessel body 17 is attached to the face 11′a of the planar body 11′ by means of for example welding or adhesive bonding. A unit dose drug F is accommodated within the blister housing 12 provided by means of the vessel body 17. The blister housing 12 provided by means of the vessel body 17 is then closed with a bottom 13′, the material properties of which are substantially similar to those previously described in relation to the bottom 13 of the support 10 of FIG. 1.

A through-hole 14′ is provided in portion A2 of the planar body 11′, which is opposite portion A1 relative to the midline plane M-M, the functions and features of which through-hole are similar to those previously described in relation to the through-hole 14 of the support 10 of FIG. 1. Details 19 relating to the specific drug F, such as for example the trade name thereof, the active ingredient, the production batch and the expiry date, are shown, for example by laser printing, in both text and bar code form preferably on surface 11a and/or 11b of the planar body 11′, in the zone which is not occupied by the blister housing 12 and by the hole 14. In this variant too, the details can be printed on one or more information labels to be applied to faces 11′a and/or 11′b of the planar body 11′, in a similar manner to that previously discussed in relation to the example of FIG. 1.

The variant of the support 10′ shown in FIG. 2 has some advantages. Providing a vessel body 17 which is separate from the planar body 11′ makes it possible to use two different materials, which is beneficial for example in the event that it is desired to make the blister housing 12 from a transparent material through which to see the drug F stored in the support 10′, and at the same time it is desired to make the planar body 11′ from an opaque material, for example white, to make it easier to apply and increase the clarity of the lettering of the details 19, where said details are printed or reproduced directly on faces 11′a, 11′b of the planar body 11′. Furthermore, handling of stacked planar bodies 11′ in an automatic system, or the production thereof for example from a strip is very simple and economic.

The support for a unit dose drug according to the present invention may also be used when the drug is supplied already enclosed in a unit dose blister pack from which it is not appropriate or possible to extract it prior to use. In the case in which the drug is supplied in a multiple dose blister pack, systems are known for subdividing them by means of cutting machines, described for example in EP 1 560 756 and EP 2 603 435 from the same applicant.

FIG. 3 shows a support 10″ for a unit dose drug contained within a blister B. The support 10″ comprises a planar body 11″, preferably but not exclusively rectangular in shape, with a through-opening 20 preferably made from one side of the planar body relative to a median transverse plane M-M of the major sides 11″c. In a similar manner to that previously described with reference to the embodiment of FIG. 1, in this case too the planar body 11″ may preferably have a through-hole 14 in the vicinity of one of the ends thereof, more preferably an end remote from the through-opening 20, and still more preferably a zone close to a corner of the planar body 11″ as shown in FIG. 3, which through-hole may be used for the same previously mentioned purposes. The information label 15 may be applied to the planar body 11″, or the details associated with drug contained in the blister B may be printed directly thereon, in a similar manner to that previously mentioned.

The through-opening 20 has a shape and dimensions which are compatible with the blister housing 21 of the blister B which contains the unit dose drug. In particular, the through-opening 20 is produced in such a manner as to permit the introduction of the blister housing 21 until one edge 22 of the blister B comes into contact with the surface of the planar body 11″, where it is attached by means of for example adhesive bonding or ultrasound welding or another equivalent system.

FIG. 4 shows a variant of the support 10″ of FIG. 3. The components of said variant are entirely similar to those previously described, and in particular include the planar body 11″ with the through-opening 20 and the through-hole 14, as well as the information label 15, which could obviously be replaced by direct printing on the planar body 11″. The difference resides in the fact that the blister B which contains the unit dose drug is attached to the planar body 11″ with the face thereof opposite the projection made by the blister housing 21. In other words, the blister housing 21 is not inserted within the through-opening 20, but remains outside it. The edge 22 of the blister B is attached to the planar body 11″ in a similar manner to that discussed previously. This variant provides greater support when withdrawing the drug by deforming and breaking the blister B. Furthermore greater flexibility and tolerance is permitted when producing the through-opening 20, which need not necessarily exactly match the outline of the blister housing 21 of the blister, possibly even being slightly smaller than it, so as to increase the surface area available for welding the edge 22 to the planar body 11″.

With the aim of providing still greater support for the blister B, it is possible to produce the planar body 11″ without removing the material of the opening 20. Some variants of this type are shown in FIGS. 5 to 7. More specifically, the variant of FIG. 5 shows a support 10″ with a planar body 11″ in which is made, for example by calibrated laser cutting, a continuous, uninterrupted incision 23, the depth of which is less than the thickness of the planar body 11″, in such a manner as to create a precut line with a profile which substantially corresponds to that of the opening 20 discussed in the preceding example. The blister B is attached to the planar body 11″ in the same manner described previously with reference to the variant of FIG. 4, namely with the planar face thereof opposite the blister housing 21 set down on the surface of the planar body 11″ and attached there by adhesive bonding or welding, for example ultrasound welding, of the edge 22. On extracting the drug from blister B, pressure exerted on the blister housing 21 by the user brings about a pressure on the drug which in turn pushes against the zone of the planar body 11″ defined by the precut incision 23 which, under said pressure, breaks, so releasing the opening it surrounds and allowing the drug to emerge.

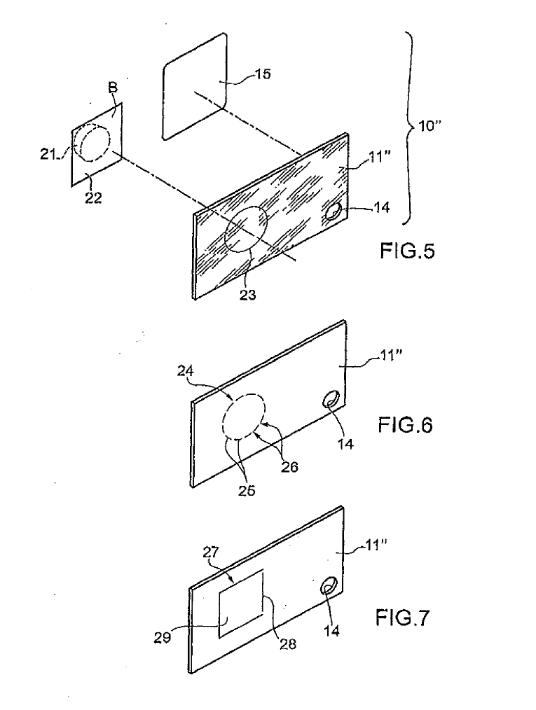

FIG. 6 shows a variant of the system just described, in which a discontinuous incision 24, for example made up of a plurality of relatively long incision sections 25 passing through the planar body 11″ alternating with relatively short unincised sections 26. The combination of incised sections 25 and unincised sections 26 forms a broken outline of an opening intended to open by breakage of the unincised zones under the pressure exerted on the blister housing of the blister B when extracting the unit dose drug.

FIG. 7 shows another variant of the system just described, in which a continuous, open incision 27 is made on the planar body 11″ along a major extent of the periphery of a geometric figure, for example along the three sides of a square as shown in FIG. 7. The zone corresponding to the fourth side 28 of the square may have an incision or precut in the manner of a plastic hinge, to facilitate bending of a tab 29 of the material of the planar body 11″ under the action of the pressure exerted on the blister housing 21 of blister B on extraction of the unit dose drug.

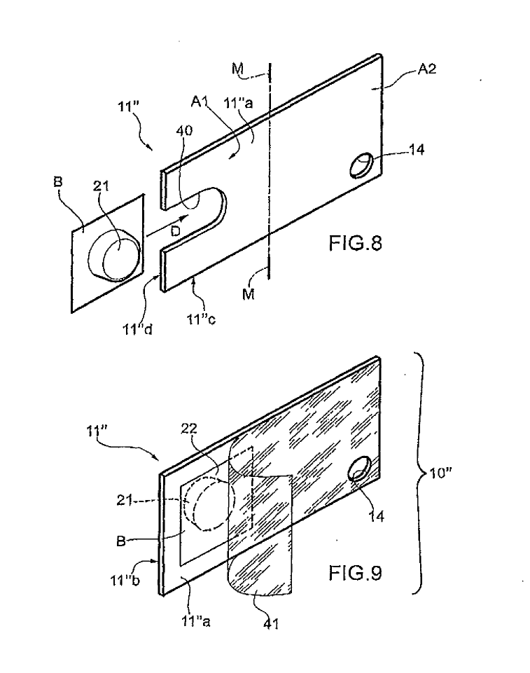

FIG. 8 shows a further variant of the support 10″ for accommodating a unit dose drug contained in a blister B. In this case, the planar body 11″ has a slot notch 40 made in one of the sides thereof, preferably the minor side 11″d of the portion A1 into which the planar body 11″ is ideally divided by the transverse midline plane M-M. The slot notch 40 permits straightforward introduction of the blister housing 21 of the blister B in a direction resting on the plane of the planar body 11″, for example along the arrow D in FIG. 8, instead of perpendicularly to the plane of the planar body 11″, as previously described in relation to the variant of FIG. 3. Advantageously, the slot notch 40 could be of substantially V-shaped configuration, in such a manner as to be able to accommodate different blisters B with blisters of differing shapes and dimensions, so eliminating the need to provide openings or slots or precuts of various shapes and dimensions for each different blister B.

FIG. 9 shows a variant of the support 10″ previously described with reference to FIG. 3, identical elements being denoted with the same reference numerals. In this case the blister B is attached to the planar body 11″ by applying a film 41 which covers the face 11″a on which the edge 22 of the blister B rests, on the opposite side to the face 11″b from which the blister housing 21 of the same blister B projects. Applying the film 41 makes the production process for the support 10″ very advantageous, simple and economic, it being possible to carry out said process according to one of the known methods for laminating or plastic coating supports.

FIG. 10 is a schematic diagram of a machine capable of manufacturing the support 10″, for example starting from a reel of semirigid material 30 from which is unwound a strip 31 which is fed towards a first cutting station 32 in which a cutting tool, preferably a laser 33, makes in the strip 31 an incision corresponding to the outline of the through-opening 20, from which the waste is subsequently removed by an implement 34. A blister B is selectively taken from a store 35 which contains unit dose drugs, the blister housing 21 of which blister is inserted into the through-opening 20 in such a manner that the edge 22 of the blister B is set down on the strip 31. In a subsequent attachment station 36, the blister B is attached to the strip 31 by means of for example ultrasound welding. A print station 37 prints the details associated with the specific drug directly onto the strip 31 or onto a label which is applied to the strip 31. A second cutting station 38 cuts the strip 31 to size to create the planar body 11″ of the support 10″.

For simplicity's sake, FIG. 10 does not show production of the through-hole 14, which may however be obtained with the same cutting laser 33 in the cutting station 32, or with a separate cutting system, before or after said cutting station 32.

The present invention has been described above with reference to some preferred embodiments and variants, which should not consequently be considered an exhaustive list of the embodiments of the invention, which may be adapted in various ways to specific requirements which can readily be identified by a relevant person skilled in the art who has read the present description. For example, the blister housing 12, the holes 14, 14′ or the openings 16, 20, the slot 40 or the precuts 23, 24, 27, may be made with geometrically different outlines from those indicated in the above-stated preferred examples, and could for example be differently shaped, either regularly or irregularly.

The materials and production processes, as well as the manufacturing technologies could differ from those indicated, in order to take advantage of products and processes would could become available in future and make the production and use of the present invention still more advantageous than has already been indicated in the present description.

Finally, the principle of the invention remaining the same, the embodiments and details of construction may be varied widely without consequently extending beyond the scope of the present invention.

1. A support for a unit dose drug, comprising a relatively rigid planar body which is elongate in shape in a first direction and has a thickness which is relatively smaller in relation to a surface area, there being provided on one portion of said surface area an accommodation area for a unit dose drug, which area is completely displaced to one side relative to a transverse midline plane, transverse of said first main direction.

2. A drug support according to claim 1, comprising at least one hole for hanging the drug support on a peg of a unit dose drug store.

3. A drug support according to claim 2, in which the hole is arranged on the opposite side of the midline relative to the accommodation area for a unit dose drug.

4. A drug support according to claim 1, in which, on the opposite side of the midline relative to the accommodation area for a unit dose drug are shown informative details about the drug, printed directly on the planar body or printed on a label attached to the planar body.

5. A drug support according to claim 1, in which the accommodation area for a unit dose drug comprises a blister housing or recess in which the unit dose drug is placed, the blister housing or recess being covered by a cover flap which is attached to the planar body and is intended to be opened during use when extracting the unit dose drug from the support.

6. A drug support according to claim 5, in which the blister housing or recess is integral with the planar body.

7. A drug support according to claim 5, in which the blister housing or recess is a vessel body inserted in an opening of the planar body and comprising an edge zone attached to the planar body.

8. A drug support according to claim 5, in which the blister housing or recess is a blister containing a unit dose drug with an edge zone attached to the planar body.

9. A drug support according to claim 5, in which the cover flap is made integral with the planar body, one or more incisions defining at least the majority of the outline of the cover flap in order to provide predetermined breaking lines.

10. A drug support according to claim 9, comprising an uninterrupted incision of a depth which is less than the thickness of the planar body.

11. A drug support according to claim 9, comprising a discontinuous incision made up of a plurality of relatively long incision sections passing through the thickness of the planar body, alternating with relatively short unincised sections, the incision sections and the unincised sections forming a broken outline for breaking.

12. A drug support according to claim 1, in which the cover flap is made integral with the planar body, comprising a continuous, open incision along a majority of a geometric profile, the zone of the planar body corresponding to the remaining minority of the geometric profile having an incision or precut in the manner of a plastic hinge, to facilitate bending of a tab of the material of the planar body acting as a cover flap of the blister housing or recess.

13. A machine for manufacturing a drug support according to claim 1 comprises a strip material feeder, a first cutting station for making a first incision in the strip, a store which contains the unit dose drugs contained in blisters, an attachment station for attaching the blister to the strip, a print station for printing details associated with the specific drug, a second cutting station for cutting the strip to the size corresponding to the planar body.

14. A machine according to claim 13, in which the first cutting station comprises a laser cutting tool and the attachment station comprises an ultrasound attachment tool.

15. A method for manufacturing a drug support according to claim 1 comprising the following steps:
feeding a strip material,
making a first incision in the strip in a first cutting station,
feeding unit dose drugs contained in blisters from a store,
attaching the blister to the strip in an attachment station,
printing details associated with the specific drug in a print station,
cutting the strip to the seize corresponding to the planar body in a second cutting station.
